(19) United States
(12) Patent Application Publication
(10) Pub. No.: US 2014/0353507 A1
(43) Pub. Date: Dec. 4, 2014

(54) APPARATUS FOR DETERMINING AND/OR MONITORING DENSITY AND/OR FILL LEVEL OF A MEDIUM IN A CONTAINER

(71) Applicant: Endress + Hauser GmbH + Co. KG, Maulburg (DE)

(72) Inventors: Dirk Glaser, Steinen (DE); Simon Weidenbruch, Lorrach (DE)

(73) Assignee: Endress + Hauser GmbH + Co. KG, Maulburg (DE)

(21) Appl. No.: 14/283,358

(22) Filed: May 21, 2014

(30) Foreign Application Priority Data
May 28, 2013 (DE) 10 2013 105 486.2

(51) Int. Cl. G01F 23/288; G01F 23/292

(52) U.S. Cl. CPC G01F 23/288; G01F 23/292
USPC 250/357.1

(57) ABSTRACT

An apparatus for determining the fill level of a medium in a container, comprising: an emitting unit to be monitored in the container and emits radioactive radiation into the container; a first detector unit receives radioactive radiation and forwards measurement data relative to the fill level of the medium to a control/evaluation unit; a second detector unit which receives the radioactive radiation, respectively the secondary radiation, wherein two interfaces for transmission of measurement data to the control/evaluation unit are associated with the second detector unit. Via the first interface measurement data are transmitted. Via the second interface measurement data are transmitted. The control/evaluation unit based on measurement data transmitted by the first detector unit and the second detector unit corrects the fill level of the medium in the container in such a manner that the influence of gas or vapor in the gas, or vapor, space on the measured fill level is at least approximately compensated.

The invention relates to an apparatus for radiometrically determining and/or monitoring density and/or fill level of a medium in a container. The medium is, especially, a liquid, a solid, a suspension or a slurry.

Contactlessly working, radiometric measuring methods are used when other measuring methods known in automation technology cannot be used, due to extreme process conditions, such as high pressure, high temperature, corrosivity, toxicity or abrasion of the medium to be monitored.

Radiometric measuring devices are applied both for limit level registration as well as also for continuous measurement of fill level, density, concentration and dividing layer in containers. In the case of radiometric fill level measurement, respectively in the case of radiometric density measurement, the container (tank or silo), in which the medium is located, is irradiated with an ionizing gamma radiation. The radiometric emitter unit, i.e. the radiation, or gamma, source, is arranged in a shielding, protective container, which is so embodied that the ionizing gamma radiation is emitted virtually from a point shaped emitter unit. The radiation source is arranged in the upper region on the outside of the container. Provided on the oppositely lying, outer surface of the container is at least one rod-shaped detector unit (scintillator). The detector unit is so embodied that it extends over the entire fill level, in which the fill level, respectively the density, of the medium located in the container is to be monitored.

The detector unit is composed either of a synthetic material or of a crystal and is so embodied that the ionizing gamma radiation passing through the container is at least partially absorbed. The absorbed radiation is partially given off in the form of UV light. Since the transmittance in synthetic material is very small for UV light, in the case of application of a scintillator of synthetic material, usually a wavelength shifter is supplementally installed in the synthetic material. The wavelength shifter converts the UV light into visible light (as a rule, into blue or green light). The, in given cases converted, light is subsequently transduced, e.g. with a photomultiplier, into electrical signals. The electrical signals are evaluated in a measurement transmitter. For evaluation, normally the light pulses are counted. Another opportunity for evaluation is to examine the amplitude spectrum, i.e. the number of pulses sorted according to amplitude. In both cases, always evaluated is the entire radiation, which has passed through the container and the medium located in the container. Depending on fill level or density of the medium, accordingly the fraction of the absorbed radiation is more or less large: The higher the fill level or the density of the medium in the container, the smaller is the detected radiation intensity.

In the case of limit level registration, the radiometric measuring is usually applied for overfilling prevention or pump protection. In the case of application for overfilling prevention, the radiation source and the detector are mounted at the height of the maximum allowable fill level of the medium on oppositely lying regions of the outer surface of the container. If the medium reaches the defined limit-level (predetermined maximum fill level), then the detected radiation intensity changes, due to the absorption of the medium, relatively rapidly from a maximum value, which in general designates the free state (medium has not achieved the limit-level), to a minimum value, which characterizes the covered state (medium has achieved the limit-level). For transmission of the measured value, usually a 4-20 mA current output is utilized. In such case, e.g. the free state corresponds to an electrical current value of 16 mA and the covered state to an electrical current value of 8 mA. The difference between the covered state and the free state is in general large in the case of liquids, since a liquid exhibits a number of half-value layers of attenuation for gamma-rays. The terminology, half-value layer, means here the thickness of medium, which is able to absorb half the incoming gamma radiation.

Frequently, an overfilling preventer is designed for safety shutdown according to a defined safety standard, e.g. according to IEC 61508 with safety integrity level of SIL 2/3. In the case of designing a measuring point, as a result of the safety requirements of the pertinent safety standard, a series of ancillary conditions must be maintained. These are exactly described in the safety manual of the limit switch and require e.g. a minimum difference between the radiation intensity in the free and covered states.

In the case of continuous fill level measurement, the radiation intensity changes continuously as a function of the height of the absorbing medium. Also in this case, a predetermined maximum fill level is referred to as the covered state and a predetermined minimum fill level is referred to as the empty state. Both states are associated with respective electrical current output signals: For example, the empty state is characterized by 4 mA, while the covered state is characterized by 20 mA. A fill level between the two limit values is ascertained via a functional relationship, usually via a linear relationship.

Problematic in the case of radiometric fill-level measurements is the pressure of the vapor, respectively the gas, in the vapor, respectively gas, space above the medium to be monitored, since this influences the ascertained fill level or density, measurement signal. If the container with the medium to be monitored is under pressure, then the gamma radiation is more strongly absorbed and the ascertained fill level, respectively the ascertained density, is correspondingly higher. This influence must be taken into consideration at start-up of the apparatus—the start-up must occur at the respectively reigning process pressure. Such influence must also be taken into consideration in the case of processes, in which the pressure, respectively the density, fluctuates in the gas, or vapor, space. Especially, in this last case, the fill level or the density of the medium in the container can only reliably be given, when occurring pressure—, respectively density, fluctuations are compensated. The corresponding compensation is usually referred to as gas phase compensation.

An opportunity for performing the gas phase compensation is directly to determine the gas, respectively vapor, density via a radiometric density measurement. This measuring is performed at the height of the maximum fill level and permits subsequently the achieving of the correct fill level measured values as a function of the density of the gas/vapor in the gas, respectively vapor, space. In such case, it is assumed that the density of the gas/vapor is essentially constant. In the case of application of an electrical current output as measurement signal, e.g. 4 mA is associated with the minimum density and 20 mA with the maximum density. However, the intensity changes, which are brought about by the density changes in the gas, or vapor, space, are very small in comparison to intensity changes due to changes in the density or the fill level of the medium. The reason for this lies in the low density of the gas/vapor compared with the density of a liquid or solid medium.

The gas phase compensation is performed in the case of known measuring devices usually in a programmable logic control (PLC) in a special process computer designed therefor. In such case, the individual measuring signals are taken into consideration. Moreover, it is known to perform the calculations for gas phase compensation in the transmitter connected with the detector unit. Preferably, the transmitter is embodied as a compact transmitter, thus a transmitter directly connected with the detector unit. The signals are fed to the transmitter via a signal input, especially a 4-20 mA electrical current input.

An object of the invention is to provide a radiometric measuring apparatus, with which the gas phase compensation can be cost effectively and reliably performed.

The object is achieved by an apparatus for determining or monitoring the fill level of a medium in a container, comprising: an emitting unit, which is arranged essentially at the height of the maximum fill level to be monitored in the container and emits radioactive radiation into the container; a first detector unit, which extends over a defined region of the container, receives radioactive radiation or a secondary radiation produced by interaction of the radioactive radiation with the medium and forwards measurement data relative to the fill level of the medium in the container to a control/evaluation unit; a second detector unit, which is arranged at the height of the maximum fill level to be monitored for the medium and which receives radioactive radiation, respectively secondary radiation, wherein two interfaces for transmission of measurement data to the control/evaluation unit are associated with the second detector unit, wherein via the first interface measurement data are transmitted, which represent information concerning reaching of the maximum predetermined fill level of the medium in the container, wherein via the second interface measurement data are transmitted, which represent the density of the gas or the density of the vapor in the gas, or vapor, space above the medium located in the container, and wherein the control/evaluation unit based on measurement data transmitted by the first detector unit and by the second detector unit corrects the fill level of the medium in the container in such a manner that the influence of gas or vapor in the gas, or vapor, space on the measured fill level is at least approximately compensated.

In an advantageous embodiment of the apparatus of the invention, the interfaces are electrical current interfaces or communication interfaces, wherein in the case of application of a communication interface a communication protocol applied in automation technology is used. For example, the communication protocol is a HART, Fieldbus Foundation or Profibus PA protocol.

Moreover, it is provided that the control/evaluation unit generates a warning signal or a switching signal, when the measurement data of the second detector unit signals reaching of the maximum allowable fill level.

An advantageous further development of the apparatus of the invention provides that the control/evaluation unit is integrated in a superordinated control unit. Alternatively, it is provided that the control/evaluation unit is integrated in one of the detector units, which, thus, supplementally performs the function of a superordinated control unit.

When the height of the container is appropriate, the first detector unit is composed of a plurality of cascaded detector units. Corresponding solutions are available from the assignee.

In the case of so-called SIL applications—safety integrity level—, the solution of the invention can only be applied when at least the second detector unit for determining the maximum fill level of the medium in the container is embodied such that it meets a predetermined safety standard. This can be e.g. SIL 1, SIL 2 or SIL 3.

In order to increase the accuracy of measurement further, for the case in which the detector unit/the detector units has/have a temperature dependence, it is provided that a temperature sensor is associated with each detector unit. Such a temperature sensor determines the temperature at the measuring location. Then, the control/evaluation unit takes the temperature reigning at the measuring location into consideration when evaluating the fill level and/or density, measurement data.

The invention will now be explained in greater detail based on the appended drawing, the figures of which show as follows:

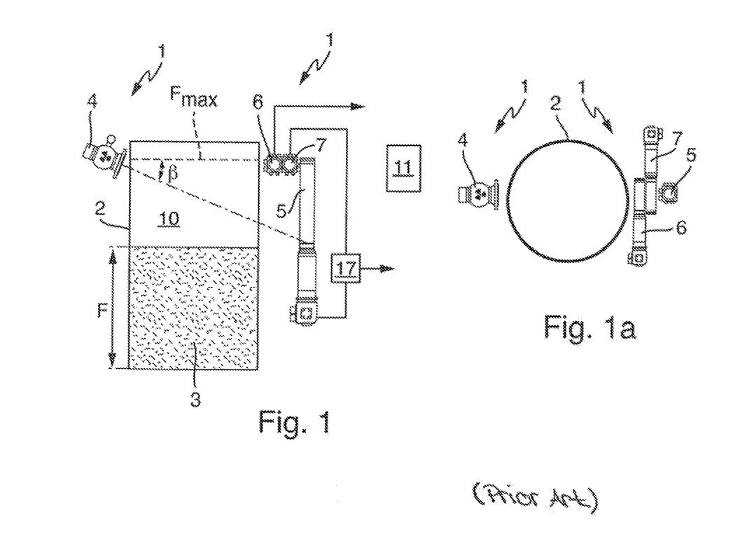

FIG. 1 a schematic representation of a radiometric measuring apparatus known from the state of the art,

FIG. 1a a plan view onto the radiometric measuring apparatus shown in FIG. 1,

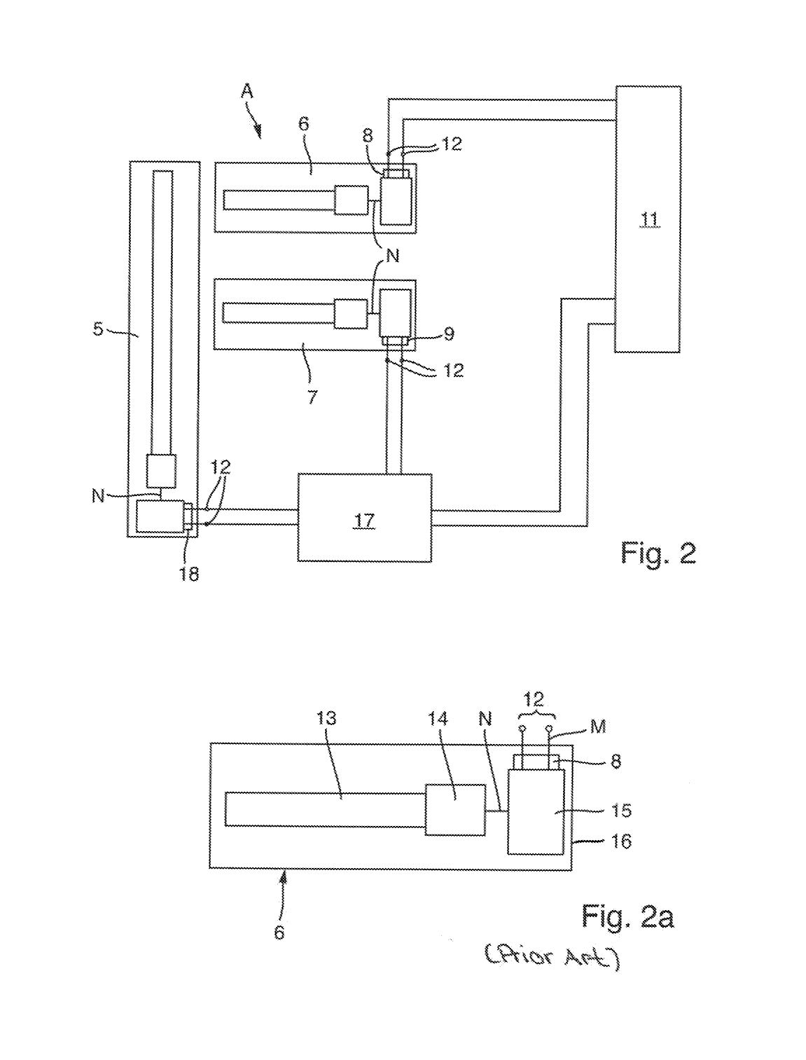

FIG. 2 a block diagram of the radiometric measuring apparatus shown in FIG. 1,

FIG. 2a an enlarged representation of the section labeled with A in FIG. 2,

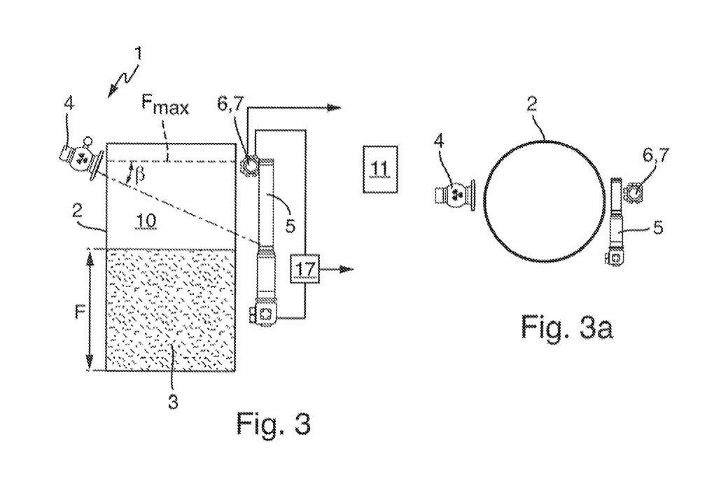

FIG. 3 a schematic representation of an embodiment of the radiometric measuring apparatus of the invention,

FIG. 3a a plan view onto the radiometric measuring apparatus of the invention shown in FIG. 3,

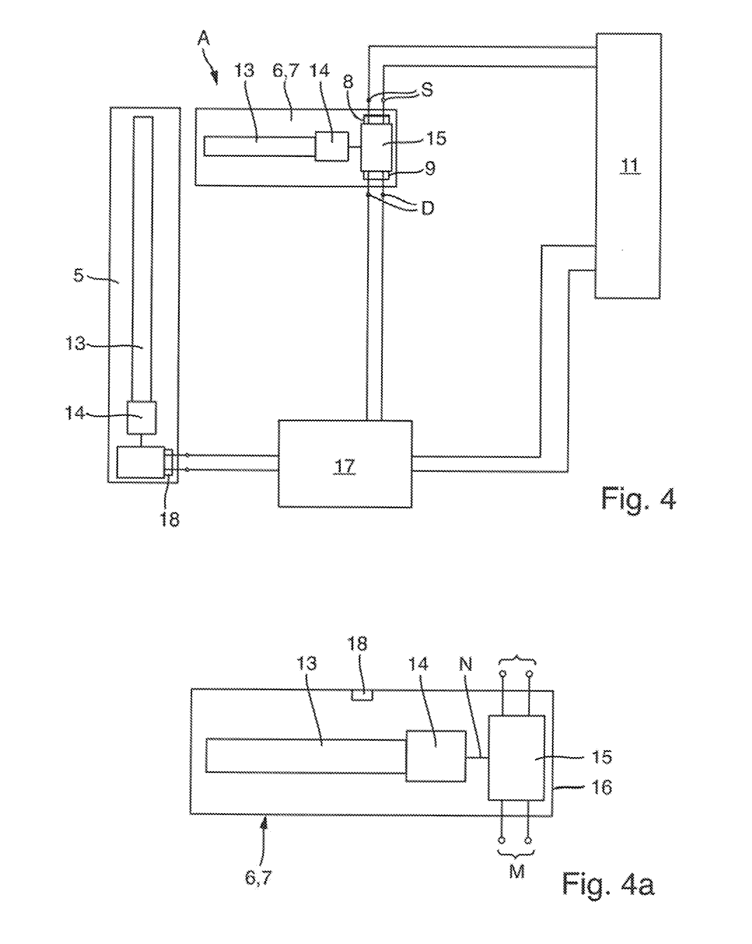

FIG. 4 a block diagram of the radiometric measuring apparatus shown in FIG. 3, and

FIG. 4a an enlarged representation of the section labeled with A in FIG. 4.

FIG. 1 shows a side view of a radiometric measuring apparatus known from the state of the art and applying gas phase compensation. FIG. 1a shows a plan view onto the radiometric measuring apparatus 1 of FIG. 1. FIG. 2 shows a block diagram of the radiometric measuring apparatus 1 shown in FIG. 1, while FIG. 2a shows an enlarged representation of the section labeled with A in FIG. 2.

Located in the container 2 is a medium 3. Medium 3 is a liquid or solid medium. The process conditions, such as temperature, pressure in the vapor, respectively gas, space, toxicity of the medium 3, etc., in the container 2 are such that, for fill level, or density, measurement in the container 2, only a contactlessly working, radiometric measuring apparatus can be applied.

The known radiometric measuring apparatus 1 is composed of a radiation source 4, a detector unit 5 for continuous fill level, or density, measurement, a detector unit 6, which fulfills the function of a safety limit switch, and a detector unit 7 for density measurement in the gas, respectively vapor, space 10. The emitting unit 4 is a radiation source, which emits gamma radiation. The emitting unit 4 is arranged in the region of the upper outer surface of the container 2, preferably at the height of the maximum fill level to be monitored, Fmax. The radiation source is embodied point-shaped and surrounded by a radiation protection container. The radiation protection container is so embodied that the gamma-rays diverge at an angle β into the container.

Provided on the oppositely lying, outer surface, likewise at the height of the maximum fill level to be monitored Fmax, are a detector unit 6 and a detector unit 7. Detector unit 6 is embodied as a safety limit switch, i.e. it is embodied such that it fulfills the requirements of a predetermined safety standard, e.g. SIL2 or SIL 3. Detector unit 7 measures the density in the gas, or vapor, space 10 located above the medium 3 in the container 2, and provides the information enabling a gas phase compensation in the case of continuous fill level, or density, measurement.

Equally provided in the region of the oppositely lying, outer surface of container 2 is the detector unit 5 for continuous fill level, or density, measurement. Detector unit 5 extends over the height of the container 2, in which the fill level or the density of the medium 3 is to be monitored. Depending on the extent of the fill level F to be monitored or the extent of the region in which density is to be monitored, in given cases, a number of detector units 5 are connected in series.

One speaks in this connection also of cascaded detector units 5.

The construction of the detector units 5, 6, 7 is essentially always the same: A detector unit 5, 6, 7 is composed at least of a scintillator 13, a photomultiplier 14, respectively a semiconductor detector (e.g. an APD), and a device electronics 15. The individual components 13, 14, 15 are mounted in a protective tube 16. If the device electronics 15 is connected directly with the scintillator 13, then such combination is referred to as a compact sensor. Via the line-pair 12, the measurement data M conditioned by the device electronics 15 are forwarded to the control/evaluation unit 17, 11. While the detector unit 5 is arranged parallel to the longitudinal axis of the container 2 and receives radiation over a correspondingly extended segment of the container 2, the detector units 6; 7 (FIG. 2) are, respectively the detector unit 6, 7 (FIG. 4) is, oriented transversely to the longitudinal axis of the container 2. Therefore, these detector units 6, 7 receive radiation only from the limited segment of the container 2, which includes the region of the maximum fill level allowable in the container 2.

FIGS. 3, 3a, 4, 4a show an embodiment of the radiometric measuring apparatus of the invention. Detector unit 5 transmits its measured values via the electrical current output 18 to the process computer 17. Detector unit 6, 7 has two electrical current outputs 8, 9. Via the electrical current output 8, the detector unit 6, 7 transmits the measured value for the safety limit switch on the PLC 11. Via the electrical current output 9, the detector unit 6, 7 transmits the density value measured in the gas, respectively vapor, space 10 to the process computer 17. Since the process computer 17 via the interface 18 also obtains the measured value for the continuous fill level, or density, measurement, the gas phase compensation can be performed in the process computer 17. The compensated fill level, or density, value is then forwarded to the PLC 11. Of course, instead of the electrical current outputs 18, 8, 9, also digital interfaces can be used, which transmit the measurement data corresponding to a protocol customary in automation technology. Examples of such transmission protocols have already been named above.

The apparatus of the invention for determining or monitoring the fill level F of a medium 3 in a container 2 includes thus components as follows:
An emitting unit 4, which is arranged essentially at the height of the maximum fill level Fmax to be monitored in the container 2 and emits the radioactive radiation, especially gamma radiation, into the container 2. The construction of the emitting unit 4 corresponds to that of gamma radiators known from the state of the art.
A detector unit 5, which extends over a defined region of the container 2, receives the radioactive radiation or secondary radiation produced by interaction of the radioactive radiation with the medium 2 and forwards the measurement data relative to the fill level F of the medium 3 in the container 2 to a control/evaluation unit 17, 11. In the illustrated case, the forwarding of the measurement data is to the process computer 17, however, the measurement data can also be forwarded directly to the PLC. In the general case, a control/evaluation unit 17, 11 is meant.
A second detector unit 6, 7, which is arranged at the height of the maximum fill level of the medium 2 to be monitored Fmax and receives the radioactive radiation, respectively the secondary radiation. Associated with the second detector unit 6, 7 are two interfaces 8, 9 for transmission of measurement data to the control/evaluation unit 17, 11. Via the first interface 8, measurement data are transmitted, which represent information concerning reaching of the maximum predetermined fill level Fmax of the medium 2 in the container 2. Via the second interface 9, measurement data are transmitted, which represent the density of the gas or the density of the vapor in the gas, or vapor, space 10 above the medium 3 located in the container 2.
A control/evaluation unit 11, 17, which, based on the measurement data transmitted from the first detector unit 6 and the second detector unit 7, corrects the fill level F of the medium 3 in the container 2 in such a manner that the influence of gas or vapor in the gas, or vapor, space on the measured fill level F is at least approximately compensated.

The great advantage of the solution of the invention is that one detector unit can be saved. Therefore, the measuring apparatus of the invention is very cost effective to implement.

### LIST OF REFERENCE CHARACTERS

1 radiometric apparatus

2 container

3 medium

4 emitting unit, gamma source, in a radiation protection container

5 detector unit for continuous fill level, or density, measurement

6 detector unit/safety limit switch

7 detector unit for density measurement in the vapor, respectively gas, space

8 first interface/first electrical current output

9 second interface/second electrical current output

10 gas, or vapor, space

11 PLC

12 line pair

13 scintillator

14 photomultiplier, respectively semiconductor detector

15 measuring device electronics, respectively transmitter

16 protective tube

17 process computer/compensation computer

1-8. (canceled)

9. An apparatus for determining or monitoring the fill level of a medium in a container, comprising:
an emitting unit, which is arranged essentially at the height of the maximum fill level to be monitored in the container and emits radioactive radiation into the container;
a first detector unit, which extends over a defined region of the container, receives radioactive radiation or a secondary radiation produced by interaction of the radioactive radiation with the medium and forwards measurement data relative to the fill level of the medium in the container to a control/evaluation unit; and
a second detector unit, which is arranged at the height of the maximum fill level to be monitored for the medium and which receives radioactive radiation, respectively secondary radiation, wherein:
two interfaces for transmission of measurement data to said control/evaluation unit are associated with said second detector unit;
via said first interface measurement data are transmitted, which represent information concerning reaching of the maximum predetermined fill level of the medium in the container;
via said second interface measurement data are transmitted, which represent the density of the gas or the density of the vapor in the gas, or vapor, space above the medium located in the container; and
said control/evaluation unit based on measurement data transmitted by said first detector unit and said second detector unit corrects the fill level of the medium in the container in such a manner that the influence of gas or vapor in the gas, or vapor, space on the measured fill level is at least approximately compensated.

10. The apparatus as claimed in claim 9, wherein:
said interfaces are electrical current interfaces or communication interfaces, wherein in the case of application of a communication interface a communication protocol applied in automation technology is used.

11. The apparatus as claimed in claim 9, wherein:
said control/evaluation unit generates a warning signal or a switching signal, when the measurement data of said second detector unit signals reaching of the maximum allowable fill level.

12. The apparatus as claimed in claim 9, wherein:
said control/evaluation unit is integrated in a superordinated control unit.

13. The apparatus as claimed in claim 9, wherein:
said control/evaluation unit is integrated in one of said detector units, which supplementally performs the function of a superordinated control unit.

14. The apparatus as claimed in claim 9, wherein:
said first detector unit is composed of a plurality of cascaded detector units.

15. The apparatus as claimed in claim 9, wherein:
at least said second detector unit for determining the maximum fill level of the medium in the container is embodied such that it meets a predetermined safety standard.

16. The apparatus as claimed in claim 9, wherein:
for the case, in which said detector units have a temperature dependence, a temperature sensor is associated with each detector unit for determining temperature at the measuring location; and
said control/evaluation unit takes the temperature reigning at the measuring location into consideration when evaluating the fill level and/or density, measurement data.
